(19) United States
(12) Patent Application Publication
(10) Pub. No.: US 2002/0162519 A1
(43) Pub. Date: Nov. 7, 2002

(54) Gas hot-water-tank air flow control mechanism

(76) Inventor: Ilio Bertolami, Saturna Island (CA)

Correspondence Address: Ilio Bertolami, Box 84, Saturna Island, BC, VON 2YO, CA

(21) Appl. No.: 10/079,398

(22) Filed: Feb. 20, 2002

(30) Foreign Application Priority Data
May 7, 2001 (CA) 2,346,802

(51) Int. Cl. F22B 37/42; F02M 59/20

(52) U.S. Cl. 122/504

(57) ABSTRACT

Envisioned at a moment when energy efficient use of natural gas or propane is considered essential to human needs and environment, this device is designed to increase the efficiency of gas-fired-hot-water-tanks. This major household appliance, widely used in North America represents a moderate to heavy consumption of energy. It addresses the problem of heat loss incurred in virtually all domestic hot-water-tank systems. In effect it is the same as closing the vent on a fireplace after the fire is out to prevent the fire created draft from sucking the air from the room. This device prevents air from randomly reaching the flame chamber, controlling it instead. It allows the flame to function as normal, but closes naturally when flame is off, effectively reducing air flow and subsequent heat loss, which would otherwise have continuous negative effect.

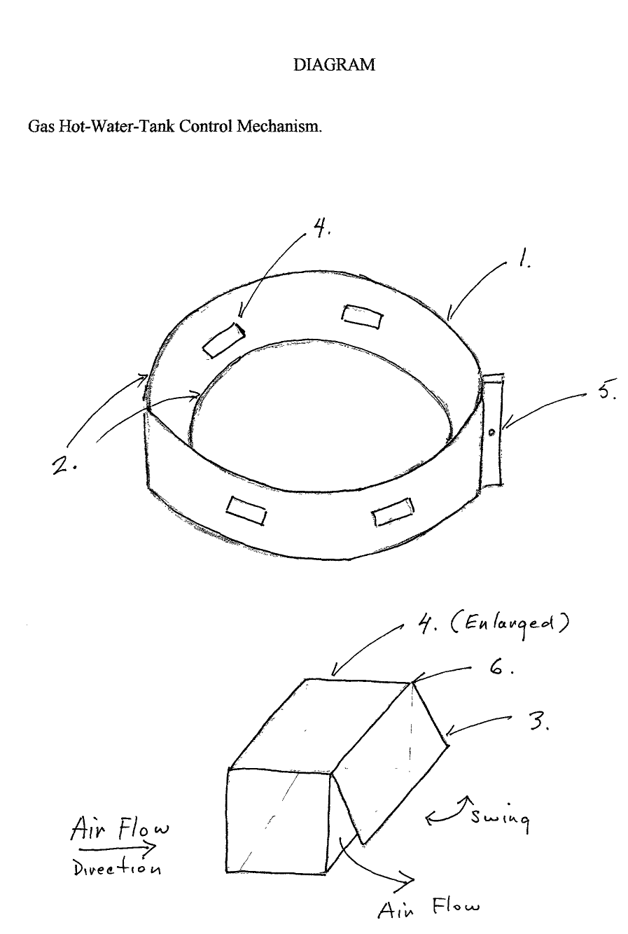

### CROSS REFERENCE TO RELATED APPLICATIONS

Not Applicable

### Statement Regarding FED Sponsored R7D

Not Applicable

### Reference to Sequence Listing

Not Applicable

### BACKGROUND OF THE INVENTION

Gas Hot-Water-Tank Air Flow Control Mechanism

The typical North American gas-hot-water-tank system involves an internal flame, and an exhaust chimney that penetrates up through the middle of the tank. An inherent inefficiency occurs after the tank has reached operating temperature and the flame shuts off. The chimney now promotes negative effect, taking heat from the tank as it continues to draft. Although this problem has been addressed on large commercial heaters by electronically controlled venting above the flame, that is, where the chimney leaves the tank, it has not been applied to domestic hot-water-tanks and it does require electricity to function. The air control mechanism I am proposing controls the air flow at the input end, or bottom of the tank, is designed primarily for domestic tank purposes, and is controlled by a balance of natural air-draw and gravity. The benefit is realized by the minimizing of uncontrolled air-flow and subsequent heat loss. One further advantage of this system is the protection against pilot-light blow out, in the event that a tank is located in a drafty location

### BRIEF SUMMARY OF THE INVENTION

Gas Hot-Water-Tank Air Flow Control Mechanism

A device for the reduction of heat loss normally incurred in presently designed gas-fired-hot-water-tanks. This invention controls the undesirable upward airflow caused by the chimney-effect after the flame has switched off. The device consists of a collar which surrounds the bottom of the tank to the floor, eliminating random airflow, while facilitating calibrated swinging portals, which allow airflow when required and cutting off air-flow upon flame switch-off. The controlling forces being, the draw created by the flame and gravity, eliminate the problems incurred with electronically controlled mechanisms.

### BRIEF DESCRIPTION OF THE DRAWING

Gas Hot-Water-Tank Air Flow Control Mechanism

1. Metal collar—Placed on lower edge of tank extending to floor.

2. Gasket air seals—Prevents exterior air from entering fire chamber.

3. Swinging portal—Control air-flow rate as required by “draw” of flame.

4. Portal housing—Supports portals.

5. Slip-fitting assembly and bolt—Secures entire collar by cinching effect

6. Hinge—Facilitates swinging gate.

### DETAILED DESCRIPTION

Gas Hot-Water-Tank Air Flow Control Mechanism

This device consists of an inflammable, impervious collar that fits snuggly around the base of the hot-water-tank, facilitated by a slip-fitting assembly. General air-flow into the flame chamber is further restricted by foam, rubber or other suitable air seal, on the upper inside edge of the collar as well as along the edge that rests on the floor. A series of inward swinging portals allow a minimal amount of air-flow as required by the pilot-light and open fully upon flame igniting to allow necessary air-flow. The natural upward draft of the flame lifts the swinging portal gate and gravity pulls it down, upon the flame shutting off. The inefficient result of the continued non-regulated upward air-flow is thereby eliminated

1. Gas Hot-Water-Tank Air Flow Control Mechanism “What I claim as my invention is a self-regulatory mechanical device that by design features controls the air flow characteristics to the flame chamber of a gas-hot-water-tank, thereby reducing unrestricted air flow and subsequent heat loss during periods when flame is “off”.
